(19) United States
(12) Patent Application Publication
(10) Pub. No.: US 2006/0046063 A1
(43) Pub. Date: Mar. 2, 2006

(54) Flexible composite having a textile substrate and fluoroplastic coated surfaces

(76) Inventor: Stephen W. Tippett, New Boston, NH (US)

Correspondence Address: Attn: Maurice E. Gauthier;Gauthier & Connors LLP, Suite 2300, 225 Franklin Street, Boston, MA, 02110, US

(21) Appl. No.: 11/194,809

(22) Filed: Aug. 1, 2005

Related U.S. Application Data
(60) Provisional application No. 60/604,751, filed on Aug. 26, 2004.

(51) Int. Cl. B32B 9/04; B32B 27/00; B32B 27/40

(52) U.S. Cl. 428/411.1; 428/421; 428/423.7; 428/415

(57) ABSTRACT

A flexible composite comprises a woven fabric textile having opposite profiled first surfaces. Fluoroplastic dispersions are applied as first coatings to the first surfaces of the textile. Fluoroplastic films are then laminated to the first coatings, with the thus laminated films having profiled second surfaces. Fluoroplastic dispersions are then applied as second coatings to the profiled second surfaces. The first and second dispersion coatings and the laminated films are sintered.

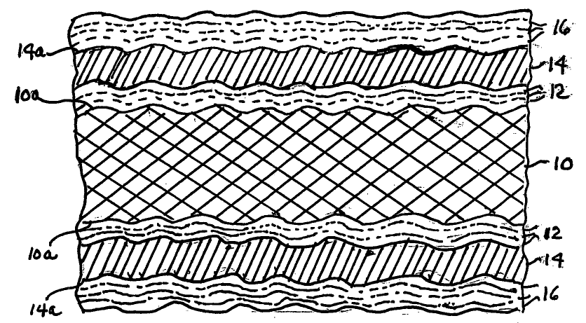

### CROSS REFERENCE TO RELATED APPLICATION

This invention claims priority from provisional patent application Ser. No. 60/604,751 filed Aug. 26, 2004.

### BACKGROUND DISCUSSION

1. Field of the Invention

This invention relates to flexible composites having fluoroplastic coated surfaces.

2. Description of the Prior Art

Flexible composites with fluoropolymer surfaces such as for example PTFE coated fiberglass fabrics have been in production for at least four or five decades. The most popular styles over time have been the lightweight fiberglass fabrics with PTFE coatings. The fiberglass fabric weights range from about 1 oz/sq yd up to around 9 oz/sq yd. The amount of PTFE coating applied can range from very low resin contents of just a few percent up to high resin contents of 60% to 70%.

Producing coated fiberglass fabrics to high resin contents has proven to be very difficult. As the resin content increases, the PTFE surface on the fabric becomes increasingly smooth, making it difficult to pick up additional PTFE resin on subsequent coating passes. This is particularly true for the lightweight fiberglass fabrics that very quickly become smooth during PTFE coating.

Demand for laminated PTFE/textile composites incorporating extruded, nonexpanded, PTFE films exists due to the limiting physical and chemical properties of PTFE coated textile composites. When compared to PTFE coated textiles, the laminated composites possess more durable properties, such as stress crack resistance, to name one property. Also, the laminated products can be made more durable in the deployment of thick, extruded, PTFE films.

However, there are some serious limitations in the production of laminated PTFE/textile composites made from extruded PTFE films. For example, extruded PTFE films, by their nature, will contain occasional holes or defects. Such films are produced via a high stress extrusion operation that can be very difficult to feed raw material through in a uniform flow. Any disruption in operation, regardless of how minor, can lead to defective areas in the extruded films. When laminated, the defective areas may develop into holes in the final composite, greatly diminishing the desired barrier properties of the product.

Also, in the production of laminated PTFE/fiberglass composites using extruded films, it can be difficult to achieve a specific final product weight due to the difficulty in producing the films at a specific film weight and thickness in the extrusion process. The film production operation, which includes both an extrusion step and one or more calendaring steps, involves a viscous PTFE paste material that does not always conform in a predictable manner to achieving the desired unsintered film properties. Variations will often be found in various film properties, e.g., density, weight, thickness, and tensile strength. For this reason, extruded film weight and thickness properties, in particular, can vary from production batch, causing corresponding variations in the weight and thickness of the laminated composite.

In the production of PTFE films, the properties of the films can be varied by the addition of pigments/fillers to the PTFE resins during the formulation of the feed stock. The amount of pigment that can be added to the PTFE resin is, to a large extent, very dependent upon the process being used to produce the film. Because extruded, unsintered, nonexpanded, PTFE films are produced in high stress extrusion operations with high reduction ratios, the amount of pigment material that can be added to the PTFE resin is limited due to the amount of friction that can be tolerated in the extrusion process. The pigment limitation can directly affect, for example, the brightness of color in an extruded PTFE film. It can also affect other desired film properties, such as color opacity or conductivity, to name two properties.

Cast PTFE films, which have been commercially available for half a century, differ from extruded PTFE films in that they are produced by applying successive coatings of a PTFE dispersion to smooth carrier belts. The belting material may be metal, or a nonmetallic material, such as a polyimide film.

The smooth conveyor belting material enables the multiple application of PTFE dispersions to form a very uniform coating. As a result, it is possible to achieve extremely thin, uniform, cast PTFE films. The cast films are very nonporous and possess excellent elongation properties.

However, these advantages are offset to a considerable extent by at least the following drawbacks. Cast PTFE films are expensive to produce because, for one reason, only smooth surfaces are used in the production of the products. Because the PTFE pick up is limited in each coating pass, many coating passes are required, which increases costs.

Also, there are limitations to the maximum thickness that can be achieved in the production of the cast PTFE film. The coating process relies upon the adhesion of the cast film to the smooth carrier belt, be it metal or polyimide material. As the thickness of film increases, the thermal expansion and contraction characteristics of the cast PTFE film tend to challenge the adhesion of the film to the carrier belt. Once the film delaminates from the carrier belt, production must be concluded. For this reason, cast films with thicknesses above 0.004″ can be difficult to produce. Also, other factors can come into play, such as the real possibility of thermal stress cracking at increased cast PTFE film thicknesses and, of course, the high cost of the multiple PTFE coatings required for the thicker films.

There exists a need, therefore, for an improved flexible composite that possesses all of the advantageous characteristics of both the known laminated PTFE/woven textile composites and cast PTFE films, without the disadvantages associated with each. It is to this end that the present invention is directed.

### SUMMARY OF THE INVENTION

The present invention stems from the discovery that PTFE dispersions can be very effectively coated successively onto laminated composites containing the extruded PTFE films described previously, thus resulting in the composites being provided with the equivalent of cast PTFE film surfaces. This is a surprise because PTFE coated fiberglass fabrics with a substantial thickness of surface PTFE tend to be very difficult products to process further with dispersion PTFE coatings.

For example, a notable amount of surface thickness of coated PTFE can often mean that the coated composite has achieved a smooth condition. This is definitely true for lightweight fiberglass fabrics with very flat profiles. The smooth surface is difficult to rewet with a PTFE dispersion coating and, as such, it is difficult to increase the product weight with additional PTFE coatings. By modifying the PTFE dispersion with certain wetting agents, it may be possible to increase the product weight with subsequent coating passes, but the increase in PTFE weight per coating pass will, typically, be very low.

Even when the PTFE coated fabric has a contoured surface profile, it can be difficult to coat with additional passes of dispersion PTFE. The pick up rate for the product diminishes with subsequent coating passes due to a “polished,” contoured, surface.

It has been found that laminated composites containing extruded PTFE film surfaces, preferably sintered extruded PTFE film surfaces, can be coated very well with PTFE dispersions. It is observed that fabrics containing the laminated films tend to possess top surface patterns matched to the patterns of the fiberglass fabrics that the films reside on. The laminated films follow the contour of the fabric, resulting in the patterned top surfaces. It is believed, that the profiled laminated PTFE top surfaces are more inclined to pick up PTFE dispersion coatings in the coating process due to an increased surface area effect.

However, even when the laminated product's PTFE surface profile appears to be very smooth due to flatness of the fabric it is residing on, the PTFE pick up during coating is surprisingly high. It is believed that this occurs because the surface of the laminated film has been somewhat roughened during the process of bonding the film to the coated fabric. The roughened surface enables the PTFE dispersion to bond well to the surface of the laminated composite, in spite of the smooth profile of the product.

As a result, it has been possible to readily modify the properties of the laminated composite by coating the composite with a variety of different PTFE dispersions. It has become possible with the PTFE coating process of the present invention to provide the extruded PTFE film surfaces of laminated composites with various advantageous characteristics, including for example:
a) one or more surface colors;
b) surface conductivity;
c) PTFE surfaces with various additives, such as metal flakes, for one example; and
d) sealed off holes or other interruptions in the laminated film, ensuring barrier integrity.

Defective areas in the laminated film are either sealed or greatly reduced in severity by the multiple PTFE dispersion coatings. The laminated film provides a solid, uniform, base for receiving the PTFE dispersion coatings. Accordingly, as the multiple PTFE dispersion coatings layer over the laminated extruded PTFE film, they develop into the equivalent of very uniform cast PTFE film surfaces.

PTFE dispersions are used in the production of PTFE coated textiles. However, the PTFE coatings on the fabrics can never acquire the excellent properties found in PTFE cast films. This is due to the very non-uniform surfaces found in all textiles materials. As the PTFE coating covers the rugged profiles of the textile materials, it never has the opportunity of establishing any uniformity. The PTFE coatings on textiles, such as fiberglass, for example, will always contain latent cracks or fissures, at the least. Due to these non-uniform traits, the coated fabrics can never be used as serious barrier materials for corrosive fluids—fluids that typically will have trouble penetrating the effective barriers formed by cast PTFE films.

Thus, the coating of PTFE dispersions onto laminated extruded PTFE films results in the formation of cast PTFE film surfaces. This is the case because the surface of the extruded film can be considered extremely uniform when compared to the surface of a textile material. The majority of the defective areas in the extruded film—the areas requiring healing with the PTFE coating—are extremely insignificant in any comparison with textile fabric surfaces. In essence, the final laminated composite contains a combination extruded PTFE film/cast PTFE film fluoroplastic composite barrier. This unique form of product possesses both the properties of the extruded film—high strength, economical cost, etc.—and the properties of the cast PTFE film—excellent nonporosity, high elongation, etc.

It is also important to note that cast PTFE films are difficult barriers to laminate onto textile reinforcements. The individual cast film is a sintered product. In order to laminate the film, it is necessary to elevate the sintered product to high temperatures—temperatures near or at the melting point of PTFE. In doing so, it becomes necessary to contend with the extreme thermal expansion forces that develop in the cast PTFE film during the heat up. Thus, special laminating equipment and/or proprietary technology may have to be considered for the production process, depending upon the properties desired in the final laminated composite. The coating process of the present invention eliminates the need for pursuing the special equipment and/or proprietary technology. By applying a PTFE dispersion to the surface of the laminated extruded PTFE film, it is possible to create insitu a textile reinforced laminated cast PTFE film.

As previously indicated, the PTFE coating process of the present invention has also made it possible to build layers of PTFE coating of different colors on top of the laminated extruded PTFE film. The multiple colors can serve as an indicator of abrasion or wear in industrial applications.

Also, the PTFE coating process of the present invention enables the production of laminated composites of precise weight. The topcoats permit incremental increases in weight for the laminated composite.

It is believed that, in part, the mechanism behind the success of the present invention is the increase in surface area that results from the initial lamination of the extruded, nonexpanded, unsintered PTFE film. The film acquires the profile of the PTFE coated textile, regardless of how slight the profile may be. The increased surface area due to the profile makes it possible for the subsequently applied PTFE coatings to increase in pick up during the coating process since the pick up is related to some degree to the surface area available for coating. The end result is a laminated composite that contains a laminated extruded PTFE film with a cast PTFE film surface.

Broadly stated, therefore, the flexible composite of the present invention comprises a woven fabric textile having opposed profiled first surfaces covered by first coatings of a fluoroplastic dispersion. Fluoroplastic films are laminated to the first coatings. The thus laminated films have profiled second surfaces to which multiple second coatings of a fluoroplastic dispersion are applied to produce cast film surfaces.

The first and second fluoroplastic dispersion coatings and the fluoroplastic films are sintered. Sintering may take place either as part of the coating or lamination steps, or alternatively at other stages in the processing of the composite.

These and other features and advantages of the present invention will now be described in greater detail with reference to the accompanying drawing.

### BRIEF DESCRIPTION OF THE DRAWING

The single FIGURE is a cross sectional view through a flexible composite in accordance with the present invention, with the thickness of component layers exaggerated for purposes of illustration.

### DETAILED DESCRIPTION OF THE INVENTION

With reference to the drawing, an exemplary embodiment of a flexible composite in accordance with the present invention comprises a woven fabric textile 10 having opposite profiled first surfaces 10a. Fluoroplastic dispersions are applied as first coatings 12 to the profiled first surfaces 10a. Fluoroplastic films 14 are laminated to the first coatings 12. The thus laminated films have profiled second surfaces 14a. Fluoroplastic dispersions are applied as second coatings 16 to the profiled second surfaces 14a, with the resulting composite thus being provided with the equivalent of cast film surfaces.

As noted previously, the first and second fluoroplastic dispersion coatings and the fluoroplastic films are sintered, either as part of the coating or lamination steps, or alternatively at other stages during processing of the composite.

As noted previously, the present invention allows for the production of laminated cast PTFE film composites with increased cast film thicknesses. When a cast PTFE film is laminated to a PTFE coated fiberglass fabric, the cast film acquires the profile of the coated fabric. Thus, the cast film, for the first time in its existence, contains a profile and the accompanying increased surface area. The profile/increased surface area is very receptive to being coated with a PTFE dispersion. Accordingly, it is possible to increase the weight of a laminated cast PTFE film/fiberglass composite by coating the composite with a PTFE dispersion. As the PTFE dispersion adheres to the laminated composite, the thickness of the laminated cast PTFE film will increase. It is expected that the amount of PTFE coating pick up per coating pass for the laminated cast PTFE film will exceed the amount of PTFE pick up per coating pass that would be expected in the actual production of the cast PTFE film prior to lamination.

It is important to point out that any laminated fluoroplastic/textile composite containing a laminated fluoroplastic film that is capable of functioning in the temperatures required for sintering PTFE dispersion coatings can benefit from the present invention. Also, a variety of fluoroplastic materials can be substituted for PTFE or added to PTFE in the implementation of the present invention. The materials can include PFA, MFA, FEP, and other high temperature fluoropolymers. In addition, various forms of fluoroelastomers can be combined with fluoroplastics to produce unique products.

The fluoropolymers of the present invention may additionally include fillers, pigments and other additives, examples of which include titanium dioxide, talc, graphite, carbon black, cadmium pigments, glass, metal powders and flakes, and other high temperature materials such as sand, fly ash, etc.

### EXAMPLE 1

Style 1080 woven fiberglass fabric, produced by JPS Industries, Slater, S.C., was coated on a vertical coating tower using a PTFE dispersion, AD-1030, from AGC Chemicals Americas, Inc., Bayonne, N.J. The PTFE solids content in the dispersion was approximately 47% by weight. Also, 0.3% by weight of Silwet L-77 surfactant, Crompton Corp., Greenwich, Conn., was added to the dispersion.

The coating tower temperature was 725 F. The production run speed for the coating passes was 4 ft/min. Four coating passes were run. The weight of the 38″ wide fiberglass fabric was 1.4 oz/sq yd. The weight of the sintered coated product after four coating passes was 3.3 oz/sq yd.

The weight of the coated product after 3 coating passes was 3.0 oz/sq yd. Thus, the pick up in PTFE weight going from the third to the fourth pass was 0.3 oz/sq yd. It has been assumed that the weight of the product would increase by 0.3 oz/sq yd or less if a fifth coating pass had been run.

### EXAMPLE 2

Using the same coating speed and coating tower temperature described in Example 1, one coating pass of the AD-1030 PTFE dispersion was applied to the style 1080 woven fiberglass fabric. The weight of the sintered coated product after one pass was 1.9 oz/sq yd.

After trimming the coated fabric to a width of 14″, extruded, unsintered, nonexpanded, PTFE films were laminated to each side of the coated fabric. The PTFE films were produced by Textiles Coated International, Amherst, N.H. The weight of each film ply was 1.6 oz/sq yd. The weight of the laminated composite was 5.1 oz/sq yd. A calendar containing a filled roll and a steel roll was used in the lamination of the extruded films. The filler material for the filled roll consisted of a mixture of cotton and wool product. Other filler materials can be selected from the group consisting of wool, paper, cotton, rubber, plastic, etc, and combinations thereof. The laminated composite was sintered in a vertical coating tower.

The laminated composite was coated on a vertical coating tower using the previously described AD-1030 PTFE dispersion, to which was added the Silwet L-77 surfactant in an amount of 0.3% by weight. A blue pigment, Toyo Lionel Blue, FG 7330, from Cleveland Pigment and Color Co., Akron, Ohio was also added to the dispersion. The total solids content of the resulting blue PTFE dispersion was around 50%. Eighty-eight percent of the solids in the dispersion were PTFE and 12% were blue pigment.

The temperature of the coating tower was again 725 F, and the production run for the coating passes was 3 ft/min. The weight of the coated laminate after the first pass was 5.7 oz/sq yd. After the second pass, the weight of the sintered product increased to 6.3 oz/sq yd.

The pick up in PTFE weight for both coating passes averaged 0.6 oz/sq yd. The pick up in PTFE coating weight in Example 1 was 0.3 oz/sq yd for the last coating pass. It is clear that the laminated composite with its extruded PTFE film surfaces was able to pick up substantially more PTFE than the coated PTFE fiberglass fabric described in Example 1. It is believed that the higher pick up in PTFE in the coated/laminated product can be attributed, in part, to the fabric profile evident in the laminated film surface. It is also felt that the surface of the laminated film, which is slightly roughened during the lamination process, contributes to the increased pick up in the dispersion coating. The coated/laminated composite contained a uniform, bright, blue color.

It should be noted that there was a slight difference in the solids content of the two PTFE dispersions used in Examples 1 and 2. The dispersion used in Example 2 contained a slightly higher solids content. However, it is believed that the increased coating pick up in Example 2 was not due to the solids contents difference. Subsequent examples show this to be the case.

### EXAMPLE 3

Style 2116 woven fiberglass fabric, produced by Hexcel-Schwebel Corporation, Stamford, Conn., was coated on a vertical coating tower using the previously described AD-1030 PTFE dispersion, to which was added 0.3% by weight of the Silwet L-77 surfactant. The PTFE solids content in the dispersion was approximately 50% by weight.

The coating tower temperature was 730 F. The production run speed for the coating passes was 6 ft/min. Seven coating passes were run using the 50% by weight dispersion. The weight of the 38″ wide fiberglass fabric was 3.06 oz/sq yd. The weight of the sintered coated product after seven coating passes was 6.7 oz/sq yd. The PTFE coating pick up on the sixth and seventh passes averaged 0.3 oz/sq yd.

The fabric was then coated with the blue PTFE dispersion described in Example 2. Two coating passes were applied in a vertical coating tower operating at 730 F. The coating speed was 3 ft/min. Each coating pass picked up 0.3 oz/sq yd of weight.

The weight of the final sintered product was 7.3 oz/sq yd. The coated product's appearance was blue in color. However, the coating was not totally uniform, with occasional dark spots. Also, the blue coating gave the appearance of being very thin with a high degree of translucency.

### EXAMPLE 4

The previously described Style 2116 woven fiberglass fabric, was coated on a vertical coating tower using the AD-1030 PTFE dispersion. The PTFE solids content in the dispersion was approximately 50% by weight. Also, 0.3% by weight of the Silwet L-77 surfactant, was added to the dispersion.

The coating tower temperature was 730 F. The production run speed for the coating passes was 6 ft/min. Two coating passes were run using the 50% by weight dispersion. The weight of the 38″ wide fiberglass fabric was 3.06 oz/sq yd. The weight of the sintered coated product after two coating passes was 4.3 oz/sq yd.

After trimming the coated fabric to a width of 14″, extruded, unsintered, nonexpanded, PTFE films were laminated to each side of the coated fabric. The

PTFE films were produced by Textiles Coated International, Amherst, N.H. The weight of each film ply was 2.0 oz/sq yd. The weight of the laminated composite was 8.3 oz/sq yd. A calendar containing a filled roll and a steel roll was used in the lamination of the extruded films. The filler material for the filled roll consisted of a mixture of cotton and wool product. The laminated composite was sintered in a vertical coating tower.

The laminated composite was coated on a vertical coating tower using the AD-1030 PTFE dispersion, with the Silwet L-77 surfactant, in an amount of 0.3% by weight. The Toyo Lionel Blue, FG 7730 pigment was also added to the dispersion. The total solids content of the blue PTFE dispersion was around 50%. Eighty-eight percent of the solids in the dispersion were PTFE and 12 percent were blue pigment.

The temperature of the coating tower was 730 F. The production run for the coating passes was 3 ft/min. The weight of the sintered coated laminate after the first pass was 8.8 oz/sq yd. After the second pass, the weight increased to 9.2 oz/sq yd. The final coating pass raised the weight to 9.5 oz/sq yd. Thus, the three coating passes were able to pick up a total of 1.2 oz/sq yd. The final sintered product exhibited a bright, uniform, blue, color that was highly opaque.

### EXAMPLE 5

Style 7628 woven fiberglass fabric, produced by Bedford Weaving Mills, Bedford, Va., was coated on a vertical coating tower using the AD-1030 PTFE dispersion. The PTFE solids content in the dispersion was approximately 53% by weight. Also, 0.3% by weight of the Silwet L-77 surfactant, was added to the dispersion.

The coating tower temperature was 730 F. The production run speed for the coating passes was 6 ft/min. Two coating passes were run using the 53% by weight dispersion. The weight of the 38″ wide fiberglass fabric was 6.0 oz/sq yd. The weight of the sintered coated product after 2 coating passes was 8.2 oz/sq yd.

After trimming the coated fabric to a width of 14″, extruded, unsintered, nonexpanded, PTFE films were laminated to each side of the coated fabric. The PTFE films were produced by Textiles Coated International, Amherst, N.H. The weight of each film ply was 3.4 oz/sq yd. The weight of the laminated composite was 15.0 oz/sq yd. A calendar containing a filled roll and a steel roll was used in the lamination of the extruded films. The filler material for the filled roll consisted of a mixture of cotton and wool product. The laminated composite was sintered in a vertical coating tower.

The laminated composite was coated on a vertical coating tower using the AD-1030 PTFE dispersion, to which the Silwet L-77 surfactant, was added in an amount of 0.3% by weight. The Toyo Lionel Blue pigment FG 7330 was also added to the dispersion. The total solids content of the blue PTFE dispersion was around 50%. Eighty-eight percent of the solids in the dispersion was PTFE and twelve was blue pigment.

The temperature of the coating tower was 730 F. The production run for the coating passes was 3 ft/min. The weight of the coated laminate after the first pass was 16.2 oz/sq yd. After the second pass, the weight increased to 17.2 oz/sq yd. The final coating pass raised the weight to 18.0 oz/sq yd. The final sintered product exhibited a bright, uniform, blue, color that was highly opaque.

It should be noted that style 2116 fiberglass fabric used in Examples 3 and 4, and the style 7628 fiberglass fabric used in Example 5, are styles that have proven over the years to be very difficult in the building of high PTFE resin composites. Both styles have very low profiles and, as a result, develop smooth surfaces early into any PTFE coating production. The smooth surfaces resist the pick up of dispersion PTFE coatings. Thus, it is remarkable that both of these styles were readily converted into the foundations for high resin content composites with the combination of laminated extruded PTFE films and coated cast PTFE film topcoats.

What is claimed is:

1. A flexible composite comprising:
a woven fabric textile having opposite profiled first surfaces;
fluoroplastic dispersions applied as first coatings to said first surfaces;
fluoroplastic films laminated to said first coatings, the thus laminated films having profiled second surfaces; and
fluoroplastic dispersions applied as second coatings to said profiled second surfaces, said first and second coatings and said films being sintered.

2. The flexible composite of claim 1 wherein the fluoroplastic of said dispersions and said films is selected from the group consisting of PTFE, PFA, FEP and MFA.

3. The flexible composite of claim 2 wherein said fluoroplastic is combined with a fluoroelastomer.

4. The flexible composite of claim 1 wherein PTFE is the fluoroplastic of at least said films and said first coatings.

5. The flexible composite of claim 1 wherein said substrate comprises woven fiberglass.

6. The flexible composite of claim 1 wherein the fluoroplastic dispersions of said second coatings include additives selected from the group consisting of titanium dioxide, talc, graphite, carbon black, cadmium pigments, glass, metal powders and flakes, sand and fly ash.

7. The flexible composite of claim 1 wherein said fluoroplastic films are extruded nonexpanded PTFE films.

8. The flexible composite of claim 1 wherein said fluoroplastic films are cast PTFE films.

9. The flexible composite of claim 1 wherein PTFE is the fluoroplastic of said first and second coatings and said films.

10. A method of producing a flexible composite comprising the steps of:
a) providing a woven fabric textile having opposite first profiled surfaces;
b) applying fluoroplastic dispersions as first coatings to said first profiled surfaces;
c) laminating fluoroplastic films to said first coatings, with the thus laminated films having exposed second profiled surfaces;
d) applying fluoroplastic dispersions as second coatings to said second profiled surfaces; and
e) sintering said first and second coatings and said films at selected stages during the production of said composite.

11. The method of claim 10 wherein the fluoroplastic of said dispersions and said films is selected from the group consisting of PTFE, PFA, FEP and MFA.

12. The method of claim 11 wherein said fluoroplastic is combined with a fluoroelstomer.

13. The method of claim 10 wherein said films are extruded unsintered unexpanded PTFE films, and wherein said films are sintered between steps (c) and (d).

14. The method of claim 10 wherein said films are cast PTFE films.

15. The method of claim 13 wherein the fluoroplastic of said dispersions is PTFE, and wherein each of said first and second coatings is sintered following each application thereof.

16. The method of claim 10 wherein said textile comprises woven fiberglass.

17. The method of claim 10 wherein the fluoroplastic dispersions of said second coatings include additives selected from the group consisting of titanium dioxide, talc, graphite, carbon black, cadmium pigments, glass, metal powders and flakes, sand and fly ash.
